(19) United States
(12) Patent Application Publication
(10) Pub. No.: US 2018/0282990 A1
(43) Pub. Date: Oct. 4, 2018

(54) Permeable Floor Panel System

(71) Applicants: MAURICIO BORREGO, Miami Gardens, FL (US); Dianelys Madiedo, Miami Gardens, FL (US)

(72) Inventors: MAURICIO BORREGO, Miami Gardens, FL (US); Dianelys Madiedo, Miami Gardens, FL (US)

(21) Appl. No.: 15/473,182

(22) Filed: Mar. 29, 2017

(51) Int. Cl. E03F 5/04; E04F 15/00; E04B 1/70; B32B 5/02; B32B 27/38

(52) U.S. Cl. CPC E03F 5/0408; E04F 15/00; E04B 1/70; B32B 5/028; B32B 2309/105; B32B 2262/101; B32B 2266/0278; B32B 2307/72; B32B 2471/00; B32B 27/38

(57) ABSTRACT

A permeable floor panel system that reduces the buildup of moisture within the walls surrounding a shower floor, that is an anti-slip floor surface, and that reduces the noise normally associated with the splashing of precipitate that accumulates on a shower floor. The permeable floor panel system comprises a silica gravel epoxy top layer hereinafter referred as the permeable layer, a fiberglass mesh layer immediately below the silica gravel epoxy top layer, a polyurethane foam layer immediately below the fiberglass mesh layer, wherein the polyurethane foam layer is designed to have channels that are inclined toward a drainage point, a fiberglass epoxy laminate frame that houses the polyurethane foam layer, the laminate frame defines a drainage pipe that leads to an existing drainage system.

### BACKGROUND

The present invention is directed to a permeable floor panel system that is used in in areas that require quick drainage of precipitate such as showers or pool decks.

The present invention is a permeable floor panel system that absorbs water at a rapid pace. The rapid pace of absorption allows any precipitate that lands on the floor panel system to almost immediately pass through the first permeable layer of the floor panel system. The rapid passage of the precipitate helps prevent the accumulation of precipitate on the floor panels. The lack of accumulation of precipitate allows the floor panel system to appear almost dry after the floor panel system absorbs the precipitate.

The texture of the top layer of the floor panel system of the present invention is ideal for anti-slip floors and thereby is ideal for use in handicap bathrooms, hospital showers, and pools.

The floor panel system of the present invention does not allow solids to pass through the permeable layer of the floor panel system, thereby ensuring that the drainage system that is below the floor panel system remains free of obstruction from solids.

The floor panel system's quick rate of absorption of the precipitate reduces the noise associated with the normal splashing of the precipitate on a surface filled with precipitate.

The quick absorption of the precipitate and the reduction of splash that occurs when precipitate hits the permeable layer of the floor panel of the present invention diminishes the moisture that accumulates within the walls that are adjacent to floor panels in normal shower stalls. The accumulation of moisture within the shower walls may lead to mold. The prevention of moisture within the walls will prevent mold and extend the life of the walls surrounding the shower floor.

The present invention is easy to install and will save the technician time when installing the system.

There is a need for a floor panel system that will reduce the buildup of moisture within the walls surrounding a shower floor, that will be an anti-slip floor surface, and that will reduce the noise normally associated with the splashing of precipitate that accumulates on a shower floor.

### SUMMARY

The present invention is a permeable floor panel system that reduces the buildup of moisture within the walls surrounding a shower floor, that is an anti-slip floor surface, and that reduces the noise normally associated with the splashing of precipitate that accumulates on a shower floor.

The floor panel system of the present invention comprises of silica gravel epoxy top layer hereinafter referred as the permeable layer, a fiberglass mesh layer immediately below the permeable layer, a polyurethane foam layer immediately below the fiberglass mesh layer, wherein the polyurethane foam layer is designed to have channels that are inclined toward a drainage point, a fiberglass epoxy laminate frame that houses the polyurethane foam layer, the laminate frame defines a drainage pipe that leads to an existing drainage system.

The permeable layer is approximately ⅜ of an inch in width and is made of a mixture of silica sand and an epoxy resin, the silica sand that is made of a plurality of silica grains that vary from 1/16 to ⅛ of an inch, the mixture is quantified as being made of 24 fluid ounces of liquid epoxy resin to 0.5 cubic feet of silica sand.

The fiberglass mesh is made of a 4.5 ounce fiberglass mesh.

The polyurethane foam layer has a density of 8 pounds per cubic feet.

The fiberglass epoxy laminate frame has a thickness of approximately 3/32 of an inch. The laminate frame provides the support needed to maintain the structure of the polyurethane foam layer.

In some embodiments of the present invention, the permeable layer may be removable and exchangeable so that different colors or styles can be placed within shower floors. When using this type of permeable layer, the permeable layer would be installed using a mortar to secure the permeable layer within the floor panel system.

An object of the present invention is to provide a floor panel system that reduces the buildup of moisture within the walls that surround a shower floor.

Another object of the present invention is to provide a floor panel system that is an anti-slip floor surface.

A further object of the present invention is to provide a floor panel system that reduces the noise normally associated with the splashing of precipitate that accumulates on a shower floor.\

### DRAWINGS

These and other features, aspects, and advantages of the present invention will become better understood with regards to the following description, appended claims, and drawings where:

FIG. 1 is a side view of how the layers of the present invention are placed upon each other and ultimately on the fiberglass epoxy laminate frame of the present invention;

FIG. 2 is a side view of how the layers would be housed within the fiberglass epoxy laminate frame;

FIG. 3 is a perspective view showing how a section of the layers are stacked upon each other;

FIG. 4 is a top view of the polyurethane foam layer showing how the channels of the polyurethane foam layer flow toward a central drainage point; and

FIG. 5 is a top view showing the fiberglass epoxy laminate frame construction and drainage.

### DESCRIPTION

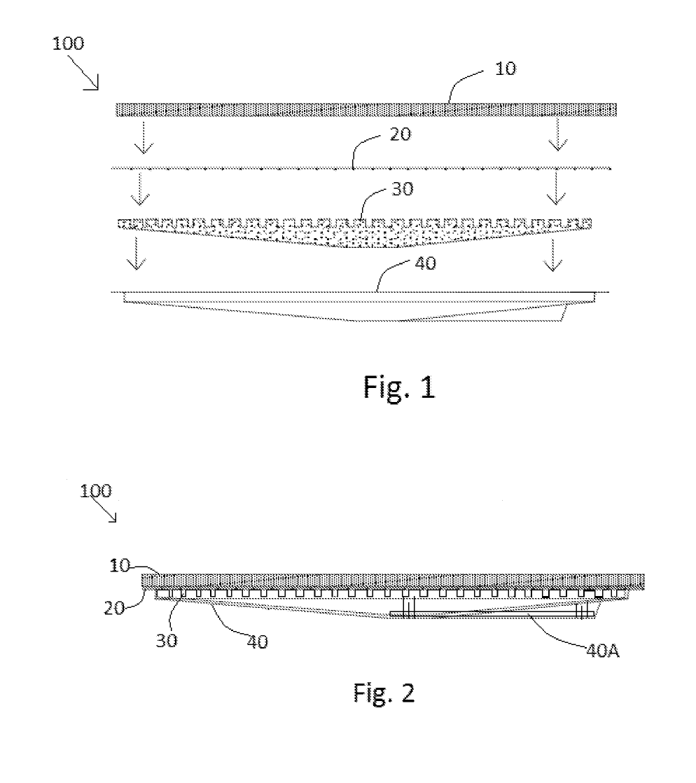

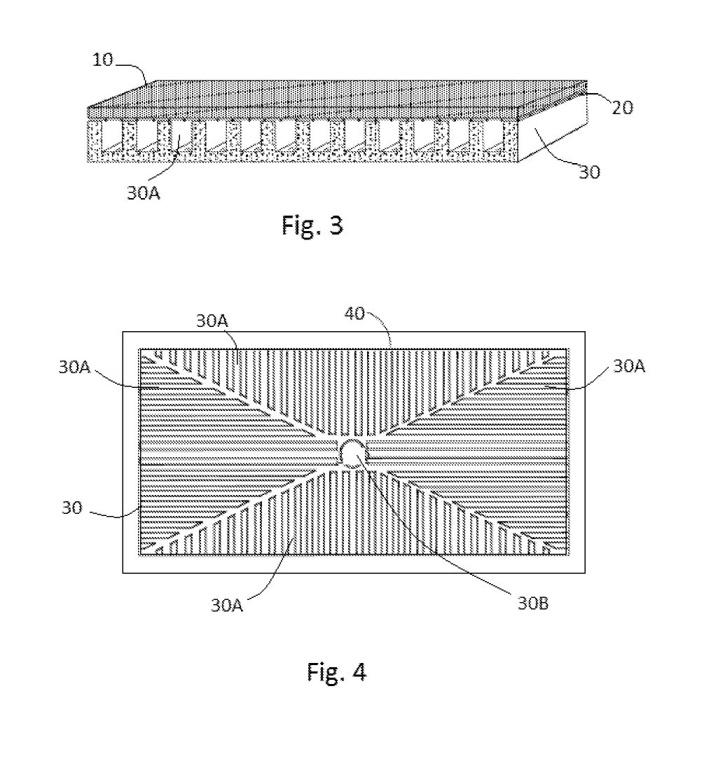

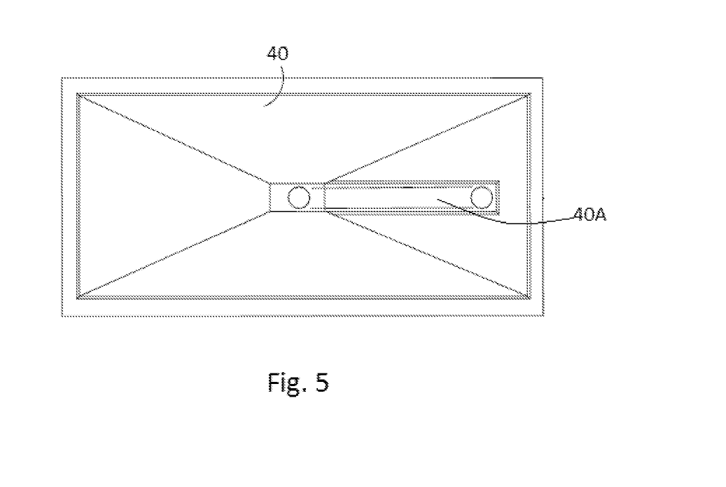

As seen in FIGS. 1-5, the present invention is a permeable floor panel system 100. The permeable floor panel system 100 comprises a silica gravel epoxy top layer 10 hereinafter referred to as the permeable layer 10, a fiberglass mesh layer 20 immediately below the permeable layer 10, a polyurethane foam layer 30 immediately below the fiberglass mesh layer 20, wherein the polyurethane foam layer 30 defines channels 30A that incline toward a drainage point 30B, a fiberglass epoxy laminate frame 40 that houses the polyurethane foam layer 30, the laminate frame 40 defines a drainage pipe 40A that leads to an existing drainage system (not shown in figures).

The permeable layer 10 is approximately ⅜ of an inch in width and is made of a mixture of silica sand and an epoxy resin, the silica sand that is made of a plurality of silica grains that vary from 1/16 to ⅛ of an inch, the mixture is quantified as being made of 24 fluid ounces of liquid epoxy resin to 0.5 cubic feet of silica sand.

The fiberglass mesh layer 20 is made of a 4.5 ounce fiberglass mesh.

The polyurethane foam layer 30 has a density of 8 pounds per cubic feet.

The fiberglass epoxy laminate frame 40 has a thickness of approximately 3/32 of an inch. The laminate frame 40 provides the support needed to maintain the structure of the polyurethane foam layer 30.

In some embodiments of the present invention, the permeable layer 10 may be removable and exchangeable so that different colors or styles can be placed within shower floors. When using this type of permeable layer, the permeable layer would be installed using a mortar to secure the permeable within the floor panel system 100.

An advantage of the present invention is that it provides a floor panel system that reduces the buildup of moisture within the walls that surround a shower floor.

Another advantage of the present invention is that it provides a floor panel system that is an anti-slip floor surface.

A further advantage of the present invention is that it provides a floor panel system that reduces the noise normally associated with the splashing of precipitate that accumulates on a shower floor.

While the inventor's above description contains many specificities, these should not be construed as limitations on the scope, but rather as an exemplification of several preferred embodiments thereof. Accordingly, the scope should not be determined by the embodiments illustrated, but by the appended claims and their legal equivalents.

What is claimed is:

1. A permeable floor panel system, the permeable floor panel system comprises:
a silica gravel epoxy top layer hereinafter referred to as the permeable layer;
a fiberglass mesh layer immediately below the permeable layer;
a polyurethane foam layer immediately below the fiberglass mesh layer, wherein the polyurethane foam layer defines channels that incline toward a drainage point; and
a fiberglass epoxy laminate frame that houses the polyurethane foam layer, the laminate frame defines a drainage pipe that leads to an existing drainage system.

2. The permeable floor panel of claim 1, wherein the permeable layer is approximately ⅜ of an inch in width and is made of a mixture of silica sand and an epoxy resin, the silica sand that is made of a plurality of silica grains that vary from 1/16 to ⅛ of an inch, the mixture is quantified as being made of 24 fluid ounces of liquid epoxy resin to 0.5 cubic feet of silica sand.

3. The permeable floor panel of claim 2, wherein the fiberglass mesh layer is made of a 4.5 ounce fiberglass mesh.

4. The permeable floor panel of claim 3, wherein the polyurethane foam layer has a density of 8 pounds per cubic feet.

5. The permeable floor panel of claim 4, wherein the fiberglass epoxy laminate frame has a thickness of approximately 3/32 of an inch.
